(19) United States
(12) Patent Application Publication
(10) Pub. No.: US 2018/0202410 A1
(43) Pub. Date: Jul. 19, 2018

(54) CONTROL DEVICE FOR INTERNAL COMBUSTION ENGINE AND METHOD FOR CONTROLLING INTERNAL COMBUSTION ENGINE

(71) Applicant: HONDA MOTOR CO., LTD., Tokyo (JP)

(72) Inventors: Masaki UENO, Wako (JP); Noritaka KIMURA, Wako (JP); Kosuke IHARA, Wako (JP)

(73) Assignee: HONDA MOTOR CO., LTD., Tokyo (JP)

(21) Appl. No.: 15/835,454

(22) Filed: Dec. 8, 2017

(30) Foreign Application Priority Data
Jan. 16, 2017 (JP) 2017-004762

(51) Int. Cl. F02P 5/15; F02D 41/00; F02D 41/14

(52) U.S. Cl. CPC F02P 5/15; F02D 41/0047; F02D 2200/0406; F02D 2200/10; F02D 2200/0404; F02D 41/1444

(57) ABSTRACT

A control device for an internal combustion engine includes ignition timing control circuitry, exhaust gas amount control circuitry, calculation circuitry, and retard circuitry. The exhaust gas amount control circuitry is configured to control an amount of exhaust gas recirculated to an intake passage via an exhaust gas recirculation passage. The calculation circuitry is configured to calculate an exhaust gas recirculation ratio of an exhaust gas amount in a combustion chamber to an entire gas amount in the combustion chamber. The retard circuitry is configured to retard ignition timing such that the ignition timing is on a retard side with respect to an optimum ignition timing at which the engine outputs maximum torque and such that the ignition timing is before a compression process end timing in a cylinder if the exhaust gas recirculation ratio is higher than a threshold ratio.

### CROSS-REFERENCE TO RELATED APPLICATIONS

The present application claims priority under 35 U.S.C. § 119 to Japanese Patent Application No. 2017-004762, filed Jan. 16, 2017, entitled “Control Device for Internal Combustion Engine.” The contents of this application are incorporated herein by reference in its entirety.

### BACKGROUND

### 1. Field

The present disclosure relates to a control device for an internal combustion engine and to a method for controlling an internal combustion engine.

### 2. Description of the Related Art

Japanese Unexamined Patent Application Publication No. 2015-124718 describes a control device which lowers a valve closing rate of a throttle valve when a deceleration operation is performed during an execution of exhaust gas recirculation in an internal combustion engine provided with an exhaust gas recirculation device and a supercharger. This control prevents an occurrence of misfire caused by an insufficient intake air amount due to the influence of recirculated exhaust gas remaining in an intake passage.

Japanese Unexamined Patent Application Publication No. 2010-90872 describes an ignition timing control device which controls ignition timing in accordance with an exhaust gas recirculation rate. According to this device, control is performed in which ignition timing is advanced along with increase of the exhaust gas recirculation rate. Further, such control is performed that a rate of an advance amount of ignition timing relative to an increase amount of the exhaust gas recirculation rate (an inclination of a line representing a relationship between the exhaust gas recirculation rate and the advance amount of ignition timing) is increased as the exhaust gas recirculation rate is increased.

### SUMMARY

According to one aspect of the present invention, a control device for an internal combustion engine includes ignition timing control circuitry, exhaust gas amount control circuitry, calculation circuitry, and retard circuitry. The ignition timing control circuitry is configured to control ignition timing in the internal combustion engine. The exhaust gas amount control circuitry is configured to control an amount of exhaust gas recirculated to an intake passage via an exhaust gas recirculation passage in the internal combustion engine. The calculation circuitry is configured to calculate an exhaust gas recirculation ratio of an exhaust gas amount in a combustion chamber of the internal combustion engine to an entire gas amount in the combustion chamber. The retard circuitry is configured to retard the ignition timing such that the ignition timing is on a retard side with respect to an optimum ignition timing at which the internal combustion engine outputs maximum torque and such that the ignition timing is before a compression process end timing in a cylinder of the internal combustion engine if the exhaust gas recirculation ratio is higher than a threshold ratio.

According to another aspect of the present invention, a control device for an internal combustion engine includes ignition timing control means, exhaust gas recirculation control means, calculation means, and retard means. The ignition timing control means controls ignition timing in the internal combustion engine. The exhaust gas recirculation control means controls an amount of exhaust gas recirculated to an intake passage via an exhaust gas recirculation passage in the internal combustion engine. The calculation means calculates an exhaust gas recirculation ratio of an exhaust gas amount in a combustion chamber of the internal combustion engine to an entire gas amount in the combustion chamber. The retard means retards the ignition timing such that the ignition timing is on a retard side with respect to an optimum ignition timing at which the internal combustion engine outputs maximum torque and such that the ignition timing is before a compression process end timing in a cylinder of the internal combustion engine if the exhaust gas recirculation ratio is higher than a threshold ratio.

According to further aspect of the present invention, a method for controlling an internal combustion engine is disclosed. The method includes controlling ignition timing of the internal combustion engine. The method includes controlling an amount of exhaust gas recirculated to an intake passage via an exhaust gas recirculation passage in the internal combustion engine. The method includes calculating an exhaust gas recirculation ratio of an exhaust gas amount in a combustion chamber of the internal combustion engine to an entire gas amount in the combustion chamber. The method includes retarding the ignition timing such that the ignition timing is on a retard side with respect to an optimum ignition timing at which the internal combustion engine outputs maximum torque and such that the ignition timing is before a compression process end timing of a cylinder of the internal combustion engine if the exhaust gas recirculation ratio is higher than a threshold ratio.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 illustrates the configurations of an internal combustion engine and a control device for internal combustion engine according to an embodiment of the present disclosure.

FIG. 2 illustrates a graph for setting a target value (REGRCMD) of an external exhaust gas recirculation rate (REGRE) in accordance with an engine load.

FIGS. 3A and 3B respectively illustrate a relationship between charging efficiency (ETAC) representing an engine load and an exhaust gas recirculation rate (REGRT) and a relationship between charging efficiency (ETAC) and engine output torque (TRQ).

FIGS. 4A and 4B respectively illustrate a relationship between ignition timing (IGLOG) and a misfire occurrence rate (RMF) in a deceleration state and a relationship between a crank angle (CA) and a gas temperature (TCYL) in a combustion chamber in a compression process.

FIG. 5 is a flowchart of ignition timing control processing including specific retard control.

FIGS. 6A to 6F are timing diagrams illustrating a first control operation example of the specific retard control.

FIGS. 7A to 7F are timing diagrams illustrating a second control operation example of the specific retard control.

FIG. 8 is a flowchart of a modification of the processing illustrated in FIG. 5.

### DESCRIPTION OF THE EMBODIMENT

The embodiments will now be described with reference to the accompanying drawings, wherein like reference numerals designate corresponding or identical elements throughout the various drawings.

An embodiment of the present disclosure will be described below with reference to the accompanying drawings.

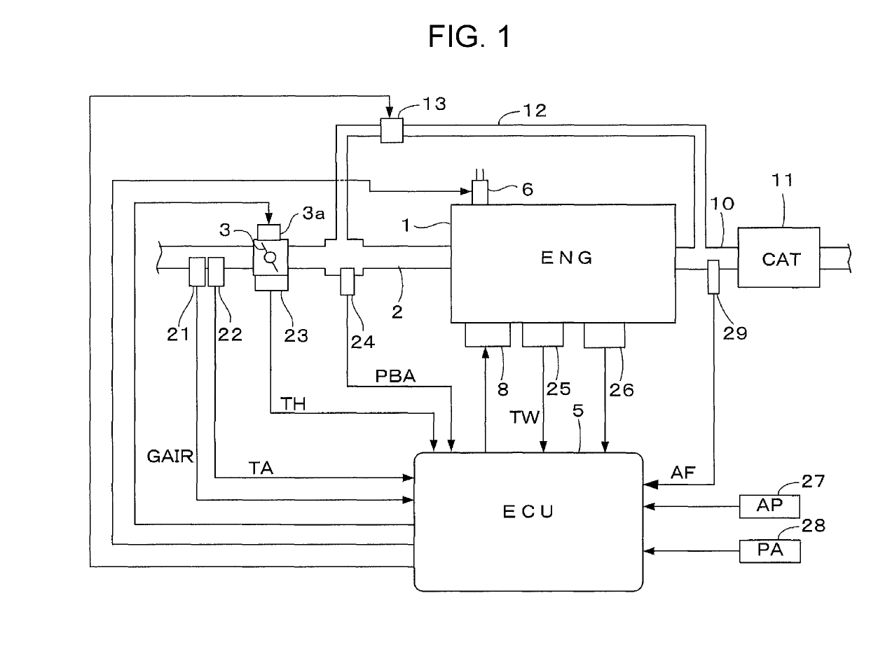

FIG. 1 illustrates the configurations of an internal combustion engine and a control device for the internal combustion engine according to an embodiment of the present disclosure. An internal combustion engine (referred to below as the “engine”) 1 illustrated in FIG. 1 includes four cylinders, for example, and an injector 6 which directly injects fuel into a combustion chamber is provided to each of the cylinders. An operation of the injector 6 is controlled by an electronic control unit (referred to below as the “ECU”) 5. Further, to each of the cylinders of the engine 1, an ignition plug 8 is attached, and ignition timing by the ignition plug 8 is controlled by the ECU 5. On an intake passage 2 of the engine 1, a throttle valve 3 is arranged.

To the ECU 5, the following sensors are connected: an intake air flow rate sensor 21 for detecting an intake air flow rate GAIR of the engine 1, an intake air temperature sensor 22 for detecting an intake air temperature TA, a throttle valve opening degree sensor 23 for detecting a throttle valve opening degree TH, an intake pressure sensor 24 for detecting an intake pressure PBA, a cooling water temperature sensor 25 for detecting an engine cooling water temperature TW, a crank angle position sensor 26 for detecting a rotation angle of a crankshaft (not illustrated) of the engine 1, an accelerator sensor 27 for detecting an accelerator pedal operation amount AP of a vehicle driven by the engine 1, an atmospheric pressure sensor 28 for detecting an atmospheric pressure PA, and other sensors which are not illustrated (a vehicle speed sensor, for example). Detection signals of these sensors are supplied to the ECU 5. The crank angle position sensor 26 outputs a plurality of pulse signals indicating a crank angle position and these pulse signals are used for various types of control of timing such as fuel injection timing and ignition timing and detection of an engine speed (rotational speed) NE.

An exhaust gas purification catalyst (a three-way catalyst, for example) 11 is provided to an exhaust passage 10. An air-fuel ratio sensor 29 is mounted on the upstream side of the exhaust gas purification catalyst 11 and the downstream side of a collecting portion of an exhaust manifold communicating with each cylinder. The air-fuel ratio sensor 29 detects oxygen concentration in exhaust gas so as to detect an air-fuel ratio AF of air-fuel mixture which burns in a combustion chamber.

The engine 1 includes an exhaust gas recirculation device, and this exhaust gas recirculation device includes an exhaust gas recirculation passage 12 which is connected with the exhaust passage 10 and the intake passage 2 and an exhaust gas recirculation control valve (referred to below as the “EGR valve”) 13 for controlling the flow rate of exhaust gas passing through the exhaust gas recirculation passage 12. An operation of the EGR valve 13 is controlled by the ECU 5.

The ECU 5 has the well-known configuration including a CPU, a memory, an input/output circuit, and the like and performs fuel injection control by the injector 6, ignition timing control by the ignition plug 8, intake air amount control by an actuator 3a and the throttle valve 3, and exhaust gas recirculation control by the EGR valve 13 in accordance with an engine operation state (mainly, the engine speed NE and a required torque TRQCMD). The required torque TRQCMD is calculated mainly in accordance with the accelerator pedal operation amount AP so that the required torque TRQCMD increases as the accelerator pedal operation amount AP increases. Further, a target intake air amount GAIRCMD is calculated in accordance with a target air-fuel ratio AFCMD and the required torque TRQCMD so that the target intake air amount GAIRCMD is approximately proportional to the target air-fuel ratio AFCMD and the required torque TRQCMD. The intake air amount control in which the throttle valve 3 is driven by the actuator 3a is performed so that an actual cylinder intake air amount is accorded with the target intake air amount GAIRCMD.

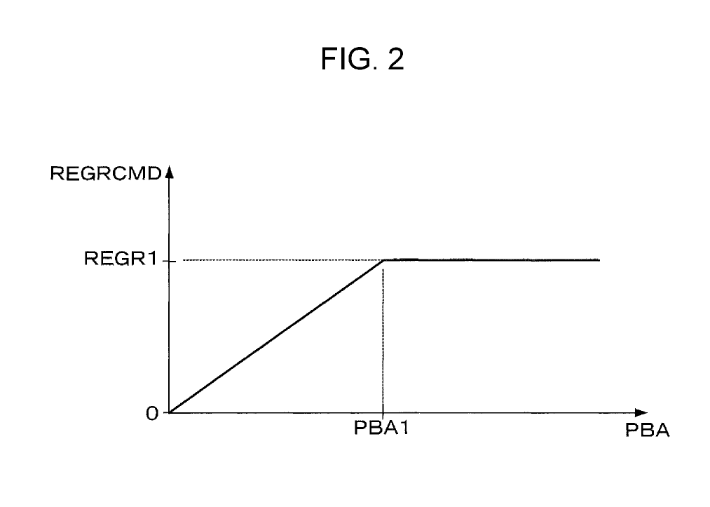

A target value REGRCMD of an external exhaust gas recirculation rate REGRE indicating a rate of an amount of exhaust gas recirculated through the exhaust gas recirculation passage 12 is set in accordance with intake pressure PBA as illustrated in FIG. 2, for example, and the opening degree of the EGR valve 13 is controlled so that an actual external exhaust gas recirculation rate REGRE is accorded with the target exhaust gas recirculation rate REGRCMD. A predetermined intake pressure PBA1 illustrated in FIG. 2 is set to approximately 53 kPa (400 mmHg) and a predetermined exhaust gas recirculation rate REGR1 is set to 20%, for example.

The fuel injection amount (mass) GINJ by the injector 6 is controlled such that the basic fuel amount GINJB calculated by using the intake air flow rate GAIR is corrected by using a target equivalence ratio KCMD and an air-fuel ratio correction coefficient KAF corresponding to the air-fuel ratio AF detected by the air-fuel ratio sensor 29. The air-fuel ratio correction coefficient KAF is calculated so that the air-fuel ratio AF to be detected (a detection equivalence ratio KACT) is accorded with a target air-fuel ratio AFCMD (the target equivalence ratio KCMD). An equivalence ratio is a parameter which is proportional to a reciprocal of the air-fuel ratio AF and takes “1.0” when the air-fuel ratio AF is equal to a theoretical air-fuel ratio (14.7). Here, the fuel injection amount GINJ is converted into valve opening time TOUT of the injector 6 by using a well-known method depending on fuel pressure PF, fuel density, and the like and controlled so that an amount of fuel to be supplied into a combustion chamber per cycle becomes equal to the fuel injection amount GINJ. The fuel injection amount GINJ is calculated by using the following formula (1).

GINJ=GINJB×KCMD×KAF×KTOTAL (1)

GINJB is a basic fuel amount which is calculated so that the air-fuel ratio of air-fuel mixture becomes equal to the theoretical air-fuel ratio AFST (=14.7) depending on the intake air flow rate GAIR, and the target equivalence ratio KCMD is expressed by the following formula (2) by using the target air-fuel ratio AFCMD. KTOTAL is a product of correction coefficients other than the target equivalence ratio KCMD and the air-fuel ratio correction coefficient KAF (for example, a correction coefficient corresponding to an engine cooling water temperature).

KCMD=AFST/AFCMD (2)

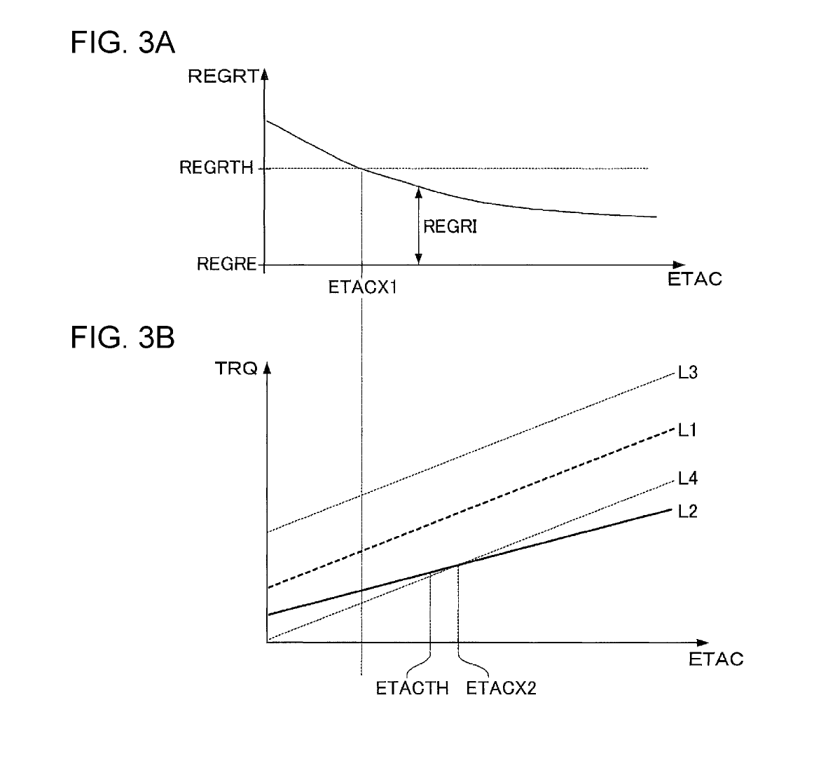

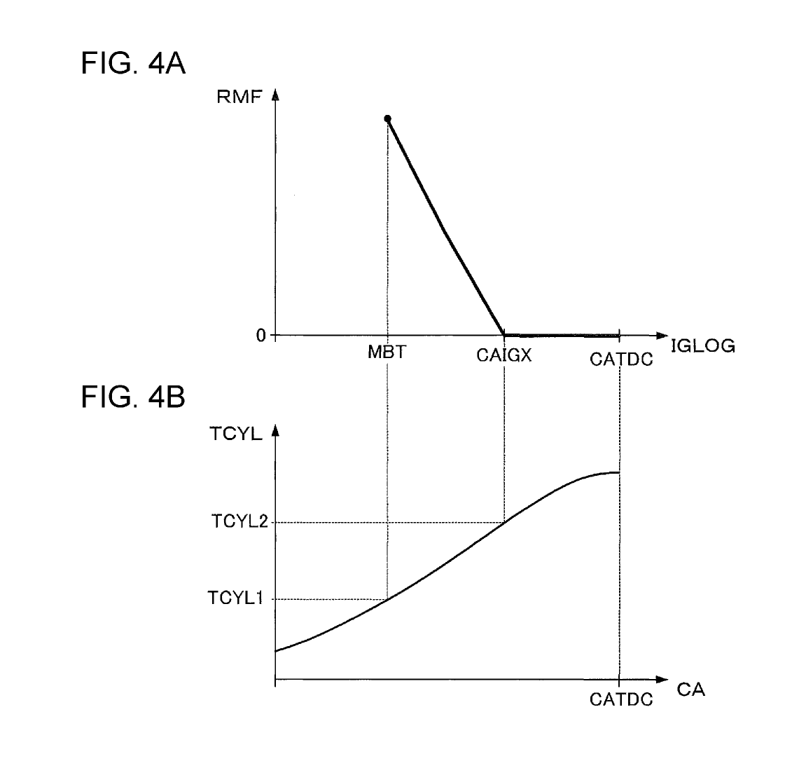

An outline of the present disclosure will now be described more specifically with reference to FIGS. 3A and 3B and FIGS. 4A and 4B. FIG. 3A illustrates a relationship between charging efficiency ETAC which is a load parameter representing a load on the engine 1 and the exhaust gas recirculation rate REGRT. The exhaust gas recirculation rate REGRT is a sum of the external exhaust gas recirculation rate REGRE and an internal exhaust gas recirculation rate REGRI which represents a rate of combustion gas remaining in a combustion chamber without being exhausted. The horizontal axis of FIG. 3A corresponds to the external exhaust gas recirculation rate REGRE which is set to 20%, for example. When an accelerator pedal is returned from a depressed state and the state shifts to a deceleration state, the charging efficiency ETAC sharply decreases while combustion gas which fills the volume obtained when a piston is at the top dead center (approximately equal to the atmospheric pressure) surely remains in the combustion chamber. Therefore, the internal exhaust gas recirculation rate REGRI increases as illustrated in FIG. 3A. As a result, when the charging efficiency ETAC becomes smaller than ETACX1 (referred to below as the “combustion destabilization boundary value”) illustrated in FIG. 3A and the exhaust gas recirculation rate REGRT exceeds a combustion destabilization threshold value REGRTH (30%, for example), misfire easily occurs.

When an accelerator pedal is returned in a cruise travelling state of a vehicle, a fuel cut operation is started in a state that the engine speed NE is relatively high. However, immediately before the fuel cut operation is started or in the case where a sudden braking operation is performed and the engine speed NE decreases to a speed close to an idle speed without performing the fuel cut operation, misfire occurs.

FIG. 4A illustrates a relationship between the ignition timing IGLOG and a misfire occurrence rate RMF in a deceleration state. The misfire occurrence rate RMF increases as the ignition timing IGLOG advances. The misfire occurrence rate RMF can be set to “0” by retarding the ignition timing IGLOG to a crank angle CAIGX illustrated in FIG. 4A. In a low load operation state such as the deceleration state, an optimum ignition timing MBT (ignition timing at which an output torque of the engine 1 is maximum) is at a crank angle which is significantly advanced from compression process end timing CATDC. Therefore, if the ignition timing IGLOG is set to the optimum ignition timing MBT, the ignition timing IGLOG is set on an advance side relative to the crank angle CAIGX and accordingly, the misfire occurrence rate RMF increases.

FIG. 4B illustrates a relationship between the crank angle CA and an in-cylinder gas temperature TCYL which is a gas temperature in the inside of a combustion chamber, in the compression process. As illustrated in FIG. 4B, the in-cylinder gas temperature TCYL at the optimum ignition timing MBT is a first temperature TCYL1, while the in-cylinder gas temperature TCYL at the crank angle CAIGX rises up to a second temperature TCYL2 along with ascending of a piston. Apparent from FIGS. 4A and 4B, by retarding the ignition timing IGLOG, ignition is performed in a state that the in-cylinder gas temperature TCYL is high, being able to prevent or suppress misfire.

Therefore, in this embodiment, misfire is suppressed by performing specific retard control in which the ignition timing IGLOG is set to specific ignition timing IGRTD which is on the retard side relative to the optimum ignition timing MBT when the exhaust gas recirculation rate REGRT becomes high in the deceleration low load operation state excluding the time during the fuel cut operation of the engine 1. Here, when the crank angle CA exceeds the compression process end timing CATDC, the in-cylinder gas temperature TCYL starts to lower, so that the compression process end timing CATDC is set to a retard limit.

FIG. 3B illustrates a relationship between the charging efficiency ETAC and output torque TRQ of the engine 1. The dashed line L1 corresponds to the case where the ignition timing IGLOG is set to the optimum ignition timing MBT and the solid line L2 corresponds to the case where the above-described specific retard control is executed. Further, the thin dashed lines L3 and L4 represent an allowable limit of the case where the output torque TRQ suddenly changes. That is, in the case where the charging efficiency ETAC is larger than a torque change allowable boundary value ETACX2 corresponding to an intersection of the solid line L2 and the dashed line L4, when the ignition timing IGLOG is switched from the optimum ignition timing MBT to the specific ignition timing IGRTD, the torque change amount exceeds the allowable limit. Therefore, in the present embodiment, the specific retard control is executed when the charging efficiency ETAC becomes smaller than a threshold value ETACTH (referred to below as the “specific retard control threshold value”). Accordingly, the torque change amount at the start of the specific retard control can be suppressed within the allowable limit.

Here, the specific retard control threshold value ETACTH is set to a value which is smaller than the torque change allowable boundary value ETACX2 and is larger than the combustion destabilization boundary value ETACX1 at which the exhaust gas recirculation rate REGRT reaches a combustion destabilization threshold value REGRTH. In actual ignition timing control, estimation charging efficiency HETAC which is an estimation value of the charging efficiency ETAC is used as described later. Therefore, the specific retard control threshold value ETACTH is set to a value which is smaller than the torque change allowable boundary value ETACX2 by approximately 10%, for example, set to approximately 18% in the view of an estimation error of the estimation charging efficiency HETAC.

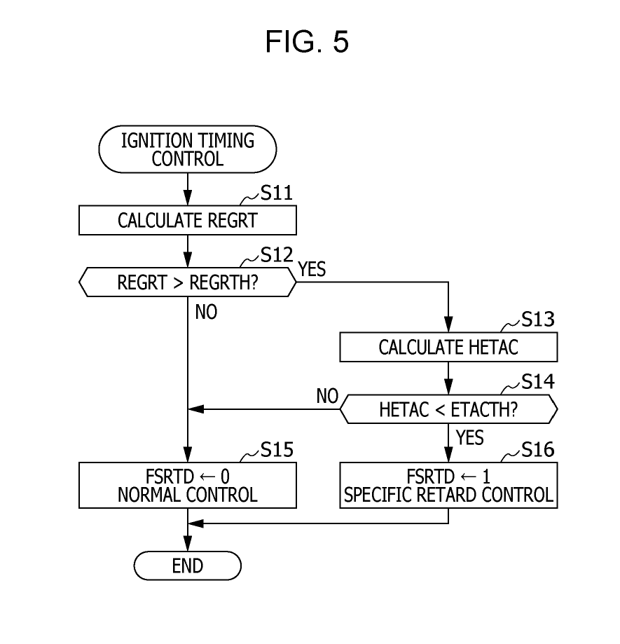

FIG. 5 is a flowchart of ignition timing control processing including the above-described specific retard control. This processing is executed every predetermined crank angle (30 degrees, for example) in synchronization with the rotation of the engine 1.

In step S11, the exhaust gas recirculation rate REGRT which is the sum of the external exhaust gas recirculation rate REGRE and the internal exhaust gas recirculation rate REGRI is calculated. This calculation of the exhaust gas recirculation rate REGRT is performed by using the well-known exhaust gas recirculation rate calculation method. The exhaust gas recirculation rate calculation method is described in, for example, Japanese Patent No. 5511898, the entire contents of which are incorporated herein by reference. To the calculation of the exhaust gas recirculation rate REGRT, an estimation intake air flow rate HGAIR is applied which is calculated based on the throttle valve opening degree TH, the intake pressure PBA, and the atmospheric pressure PA, which are detected. That is, a cylinder intake air amount GAIRCYL which is a fresh air amount is calculated by using the estimation intake air flow rate HGAIR so as to be applied to the calculation of the exhaust gas recirculation rate REGRT. The estimation intake air flow rate HGAIR is calculated by using the well-known calculation method. This calculation method is described in, for example, Japanese Patent No. 5118247, the entire contents of which are incorporated herein by reference.

In step S12, whether or not the exhaust gas recirculation rate REGRT is larger than the combustion destabilization threshold value REGRTH is determined. When the answer of step S12 is negative (NO), a specific retard control flag FSRTD is set to “0” and normal control is performed (step S15). In the normal control, the ignition timing IGLOG is set to the optimum ignition timing MBT in the relatively-low-load operation state in which knocking limit ignition timing is on the advance side relative to the optimum ignition timing MBT.

When the answer of step S12 is affirmative (YES) and the exhaust gas recirculation rate REGRT exceeds the combustion destabilization threshold value REGRTH, the estimation charging efficiency HETAC [%] is calculated by applying the cylinder intake air amount GAIRCYL to the following formula (3) (step S13).

HETAC=(GAIRCYL/GAIRBASE)×100 (3)

Here, GAIRBASE represents an amount of air filling the combustion chamber when the piston is at the bottom dead center in a standard atmospheric condition (for example, atmospheric pressure 101.3 kPa, temperature 20° C., degree of humidity 60%), and a value calculated in advance is applied to GAIRBASE.

In step S14, whether or not the estimation charging efficiency HETAC is smaller than the specific retard control threshold value ETACTH is determined. When the answer of step S14 is negative (NO), the processing goes to step S15. When the answer of step S14 is affirmative (YES), the specific retard control flag FSRTD is set to “1” and the specific retard control in which the ignition timing IGLOG is set to the specific ignition timing IGRTD is executed. The specific ignition timing IGRTD is calculated by searching an IGRTD map (not illustrated) which is set in accordance with the engine speed NE and the estimation charging efficiency HETAC. The IGRTD map is set so that the specific ignition timing IGRTD is advanced as the engine speed NE is increased and the specific ignition timing IGRTD is retarded as the estimation charging efficiency HETAC is lowered. Here, the compression process end timing CATDC is set to the retard limit as described above. The ignition timing IGLOG is defined by the advance amount with reference to the compression process end timing CATDC (0). Therefore, the specific ignition timing IGRTD is set to a value which is smaller than the optimum ignition timing MBT and equal to or larger than “0”.

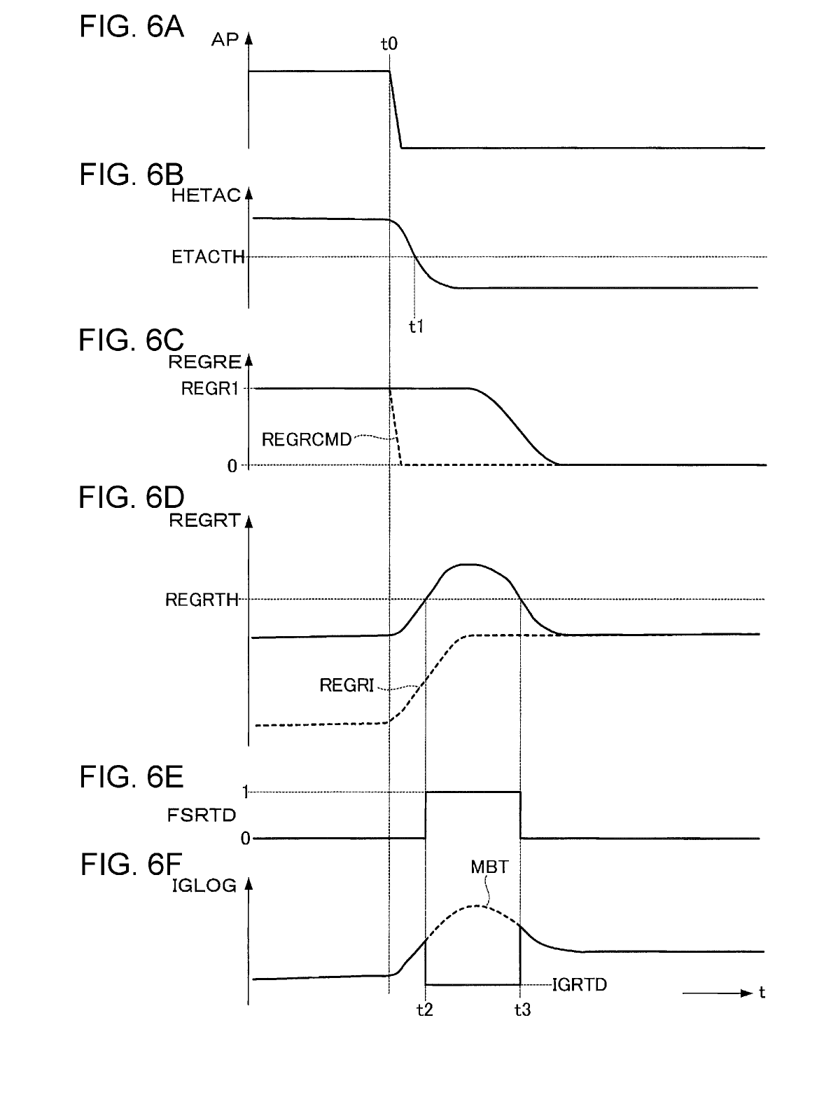

FIGS. 6A to 6F are timing diagrams illustrating a first control operation example of the above-described specific retard control. FIGS. 6A to 6F illustrate transition of the accelerator pedal operation amount AP, the estimation charging efficiency HETAC, the external exhaust gas recirculation rate REGRE, the exhaust gas recirculation rate REGRT, the specific retard control flag FSRTD, and the ignition timing IGLOG respectively.

When an accelerator pedal is returned at time to, a target value REGRCMD of the external exhaust gas recirculation rate is returned from the predetermined exhaust gas recirculation rate REGR1 to “0” (FIGS. 6A and 6C). The estimation charging efficiency HETAC starts to decrease from time t0 and falls below the specific retard control threshold value ETACTH at time t1 (FIG. 6B). Even though the target value REGRCMD is set to “0”, reduction of the external exhaust gas recirculation rate REGRE delays, while the internal exhaust gas recirculation rate REGRI increases immediately after time t0. Accordingly, the exhaust gas recirculation rate REGRT exceeds the combustion destabilization threshold value REGRTH at time t2 (immediately after time t1) (FIGS. 6C and 6D). As a result, the specific retard control flag FSRTD is set to “1” and the specific retard control is started (FIGS. 6E and 6F).

Due to the decrease of the external exhaust gas recirculation rate REGRE, the exhaust gas recirculation rate REGRT falls below the combustion destabilization threshold value REGRTH at time t3 (FIG. 6D). As a result, the specific retard control flag FSRTD is returned to “0” and the specific retard control is ended (FIGS. 6E and 6F).

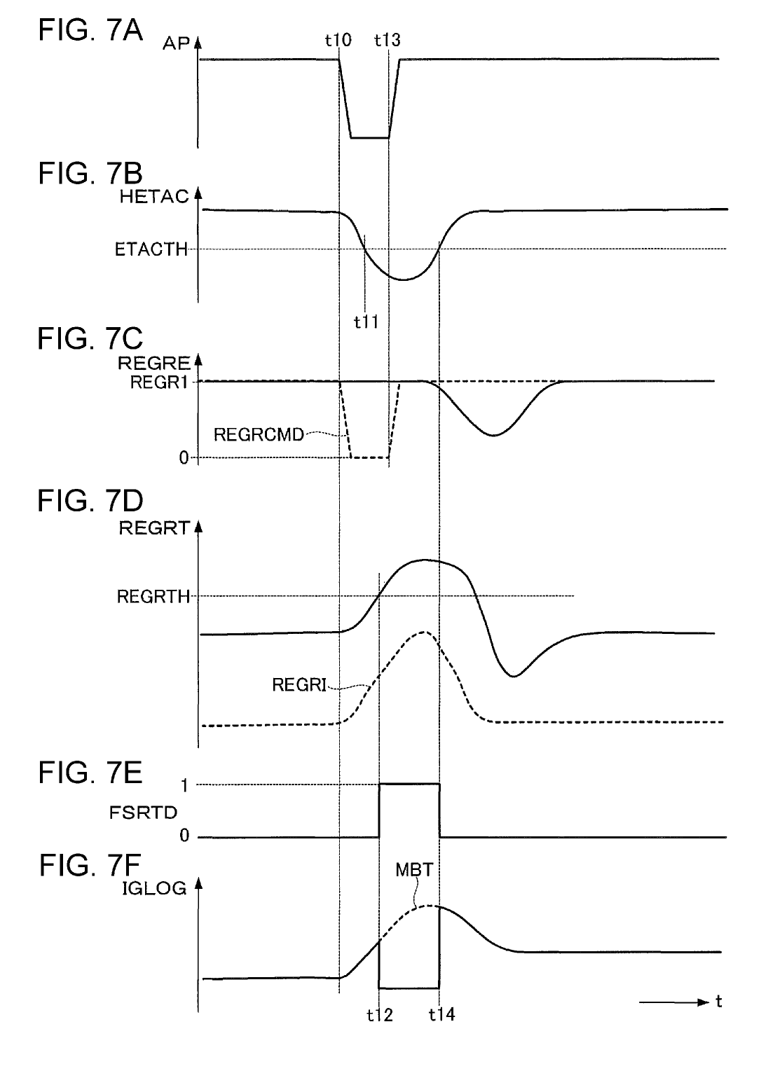

FIGS. 7A to 7F are timing diagrams illustrating a second control operation example of the above-described specific retard control. FIGS. 7A to 7F illustrate transition of the accelerator pedal operation amount AP, the estimation charging efficiency HETAC, the external exhaust gas recirculation rate REGRE, the exhaust gas recirculation rate REGRT, the specific retard control flag FSRTD, and the ignition timing IGLOG respectively, as is the case with FIGS. 6A to 6F.

When an accelerator pedal is returned at time t10, the target value REGRCMD of the external exhaust gas recirculation rate is returned from the predetermined exhaust gas recirculation rate REGR1 to “0” (FIG. 7C). The estimation charging efficiency HETAC starts to decrease from time t10 and falls below the specific retard control threshold value ETACTH at time t11 (FIG. 7B). Even though the target value REGRCMD is set to “0”, reduction of the external exhaust gas recirculation rate REGRE delays, while the internal exhaust gas recirculation rate REGRI increases immediately after time t10. Accordingly, the exhaust gas recirculation rate REGRT exceeds the combustion destabilization threshold value REGRTH at time t12 (immediately after time t11) (FIGS. 7C and 7D). As a result, the specific retard control flag FSRTD is set to “1” and the specific retard control is started (FIGS. 7E and 7F).

The accelerator pedal is depressed at time t13 and the estimation charging efficiency HETAC starts to increase with a slight delay (FIGS. 7A and 7B). Since the estimation charging efficiency HETAC exceeds the specific retard control threshold value ETACTH at time t14, the specific retard control flag FSRTD is returned to “0” and the specific retard control is ended (FIGS. 7B, 7E, and 7F). Here, the external exhaust gas recirculation rate REGRE starts to decrease immediately before time t14 in accordance with temporary decrease of the target value REGRCMD and then, the external exhaust gas recirculation rate REGRE returns to the predetermined exhaust gas recirculation rate REGR1 (FIG. 7C).

As described above, in the present embodiment, when the exhaust gas recirculation rate REGRT exceeds the combustion destabilization threshold value REGRTH and the estimation charging efficiency HETAC is smaller than the specific retard control threshold value ETACTH, the specific retard control is executed in which the ignition timing IGLOG is set to the specific ignition timing IGRTD which is on the retard side relative to the optimum ignition timing MBT with the compression process end timing used as a retard limit. In the low load state such as the deceleration state of the engine 1, external exhaust gas recirculation is stopped but exhaust gas remaining in the intake passage 2 is sucked into the combustion chamber and added to residual combustion gas of the inside of the combustion chamber. Meanwhile, the exhaust gas recirculation rate REGRT temporarily increases because the intake air amount is small. Accordingly, a possibility of an occurrence of misfire increases. The in-cylinder gas temperature TCYL is increased by compression in the compression process. Therefore, ignition is performed at the specific ignition timing IGRTD which is on the retard side relative to the optimum ignition timing MBT with the compression process end timing CATDC used as the retard limit. Accordingly, more stable ignition can be performed compared to the case where ignition is performed at the optimum ignition timing MBT, being able to suppress misfire.

Further, when the estimation charging efficiency HETAC representing a load on the engine 1 is equal to or larger than the specific retard control threshold value ETACTH in the case where the exhaust gas recirculation rate REGRT exceeds the combustion destabilization threshold value REGRTH, the specific retard control is not executed. In the state that an engine load is high to some extent, combustion energy is large and therefore, there is almost no possibility of an occurrence of misfire. Meanwhile, an adverse effect that the reduction amount of the engine output torque at the starting time of the specific retard control becomes large arises. Accordingly, in the case where the estimation charging efficiency HETAC is equal to or larger than the specific retard control threshold value ETACTH, the specific retard control is not executed, that is, the ignition timing IGLOG is set to the optimum ignition timing MBT, being able to prevent such adverse effect.

Further, the specific ignition timing IGRTD is set to be retarded as the estimation charging efficiency HETAC is decreased. The combustion energy is decreased as the engine load is lowered and air-fuel mixture becomes difficult to ignite. Therefore, the specific ignition timing IGRTD is retarded as the estimation charging efficiency HETAC is decreased, enabling stable ignition.

The cylinder intake air amount GAIRCYL which is an amount of fresh air sucked into the combustion chamber is calculated based on the throttle valve opening degree TH and the intake pressure PBA which are detected, and the cylinder intake air amount GAIRCYL is applied to calculation of the exhaust gas recirculation rate REGRT. In the steady operation state of the engine 1, it is possible to accurately calculate the cylinder intake air amount GAIRCYL based on the intake air flow rate GAIR which is detected by the intake air flow rate sensor 21 arranged in the intake passage 2. However, in the deceleration state (transient state), the cylinder intake air amount GAIRCYL calculated based on the throttle valve opening degree TH and the intake pressure PBA which are detected is more accurate. Accordingly, by using the cylinder intake air amount GAIRCYL thus calculated, the exhaust gas recirculation rate REGRT exhibiting higher accuracy can be obtained in the deceleration state.

It is possible to use the above-mentioned cylinder intake air amount GAIRCYL or intake pressure PBA, for example, as a parameter representing a load on the engine 1. However, by using the estimation charging efficiency HETAC, a load on the engine 1 can be more accurately grasped, and determination of an execution condition of the specific retard control and setting of the specific ignition timing IGRTD corresponding to the engine load can be accurately performed.

In the present embodiment, the throttle valve opening degree sensor 23 and the intake pressure sensor 24 respectively correspond to a throttle valve opening degree detection unit (throttle valve opening degree detection circuitry) and an intake pressure detection unit (intake pressure detection circuitry), the ECU 5 constitutes an ignition timing control unit (ignition timing control circuitry), a part of an exhaust gas recirculation control unit (exhaust gas recirculation control circuitry), an exhaust gas recirculation rate calculation unit (calculation circuitry), and retard circuitry, and the EGR valve 13 constitutes a part of the exhaust gas recirculation control unit (exhaust gas recirculation control circuitry).

### MODIFICATION

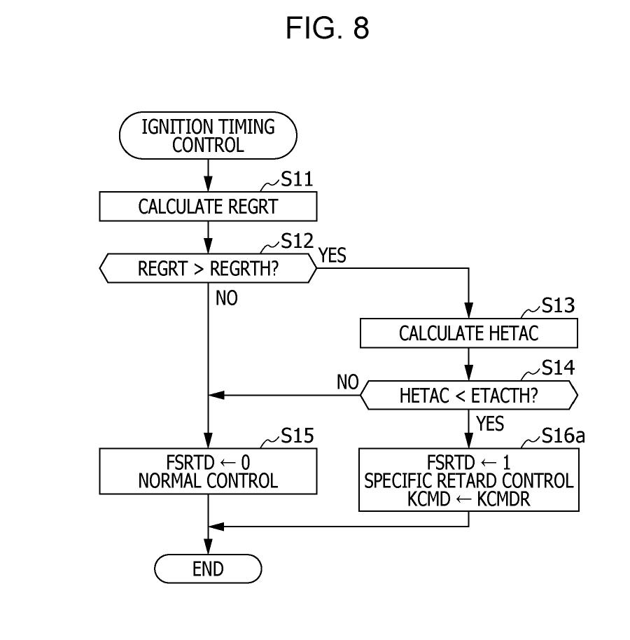

FIG. 8 is a flowchart of a modification of the processing illustrated in FIG. 5. In FIG. 8, step S16 of FIG. 5 is changed to step S16a.

In step S16a, the target equivalence ratio KCMD which is set in the air-fuel ratio control processing, which is not illustrated, is changed to a rich equivalence ratio KCMDR which is larger than “1.0” when the specific retard control is executed. Here, when the normal control is executed in step S15, the target equivalence ratio KCMD is set to “1.0” by the air-fuel ratio control processing.

The present modification takes into account the case where variation is generated among air-fuel ratios of cylinders due to property variation or deterioration state variation among the injectors 6 provided to respective cylinders of the engine 1 and the air-fuel ratios of some of the cylinders deviate from the theoretical air-fuel ratio to the lean side. By setting the target equivalence ratio KCMD to the rich equivalence ratio KCMDR when the specific retard control is executed, misfire can be securely prevented or suppressed even in cylinders provided with injectors whose fuel injection amount is relatively decreased. The rich equivalence ratio KCMDR is set to a value corresponding to a state that air-fuel ratio variation among cylinders is the maximum in an allowable range, for example, set to approximately “1.1”.

It should be noted that the present disclosure is not limited to the above-described embodiment and can be variously modified. For example, the specific ignition timing IGRTD is retarded as the estimation charging efficiency HETAC is lowered in the above-described embodiment, but setting may be performed depending only on the engine speed NE without depending on the estimation charging efficiency HETAC.

Further, the example in which the present disclosure is applied to the control device for internal combustion engine including a cylinder injector which directly injects fuel into a combustion chamber is described in the above-described embodiment. However, the present disclosure is applicable also to a control device for internal combustion engine including an intake passage injector which injects fuel into the intake passage 2 or for internal combustion engine including a cylinder injector and an intake passage injector. Further, the present disclosure is applicable also to a control device for internal combustion engine including a supercharger.

According to the first aspect of the present disclosure, a control device for internal combustion engine provided with an exhaust gas recirculation passage for recirculating exhaust gas to an intake passage includes an ignition timing control unit that controls ignition timing (IGLOG) of the engine, an exhaust gas recirculation control unit that controls an amount of exhaust gas recirculated to the intake passage via the exhaust gas recirculation passage, and an exhaust gas recirculation rate calculation unit that calculates an exhaust gas recirculation rate (REGRT) representing a rate of an amount of exhaust gas in an inside of a combustion chamber with respect to a whole amount of gas existing in the combustion chamber of the engine, in which the ignition timing control unit executes specific retard control in which the ignition timing (IGLOG) is set to specific ignition timing (IGRTD), which is on a retard side relative to an optimum ignition timing (MBT), at which output torque of the engine reaches maximum, with a compression process end timing of a control object cylinder used as a retard limit, when an exhaust gas recirculation rate (REGRT) that is calculated exceeds a predetermined threshold value (REGRTH).

According to this configuration, when the exhaust gas recirculation rate exceeds the predetermined threshold value, the specific retard control is executed in which the ignition timing is set to the specific ignition timing which is on the retard side relative to the optimum ignition timing with the compression process end timing used as a retard limit. In the low load state such as the deceleration state of the engine, exhaust gas recirculation via the exhaust gas recirculation passage is stopped but exhaust gas remaining in the intake passage is sucked into the combustion chamber and added to residual combustion gas of the inside of the combustion chamber. Meanwhile, the exhaust gas recirculation rate temporarily increases because the intake air amount is small. Accordingly, a possibility of an occurrence of misfire increases. The gas temperature in the inside of the combustion chamber is increased by compression in the compression process. Therefore, ignition is performed at the specific ignition timing which is on the retard side relative to the optimum ignition timing with the compression process end timing used as the retard limit. Accordingly, more stable ignition can be performed compared to the case where ignition is performed at the optimum ignition timing, being able to suppress misfire.

According to the second aspect of the present disclosure, in the control device for internal combustion engine according to the first aspect, when a load parameter (HETAC) representing a load on the engine is equal to or larger than a predetermined load parameter value (ETACTH) in a case where the exhaust gas recirculation rate (REGRT) exceeds the predetermined threshold value (REGRTH), it is preferable that the ignition timing control unit does not execute the specific retard control.

According to this configuration, when the load parameter representing a load on the engine is equal to or larger than the predetermined load parameter value in the case where the exhaust gas recirculation rate exceeds the predetermined threshold value, the specific retard control is not executed. In the state that an engine load is high to some extent, combustion energy is large and therefore, there is almost no possibility of an occurrence of misfire. Meanwhile, an adverse effect that the reduction amount of the engine output torque at the starting time of the specific retard control becomes large arises. Accordingly, in the case where the load parameter is equal to or larger than the predetermined load parameter value, the specific retard control is not executed, that is, the ignition timing is set to the optimum ignition timing, being able to prevent such adverse effect.

According to the third aspect of the present disclosure, in the control device for internal combustion engine according to the first or second aspect, the ignition timing control unit preferably retards the specific ignition timing (IGRTD) as the load parameter (HETAC) is decreased.

According to this configuration, the specific ignition timing is set to be retarded as the load parameter is decreased. The combustion energy is decreased as the engine load is lowered and air-fuel mixture becomes difficult to ignite. Therefore, the specific ignition timing is retarded as the load parameter is decreased, enabling stable ignition.

According to the fourth aspect of the present disclosure, in the control device for internal combustion engine according to any one of the first to third aspects, the engine preferably includes a throttle valve provided to the intake passage, the control device for internal combustion engine preferably further includes a throttle valve opening degree detection unit that detects an opening degree of the throttle valve (TH), and an intake pressure detection unit that detects intake pressure (PBA) of the engine, and the exhaust gas recirculation rate calculation unit preferably calculates an amount of fresh air (GAIRCYL) sucked into the combustion chamber based on a throttle valve opening degree (TH) and intake pressure (PBA), which are detected, and preferably uses the amount of fresh air, which is calculated, for calculation of the exhaust gas recirculation rate (REGRT).

According to this configuration, an amount of fresh air sucked into the combustion chamber is calculated based on the throttle valve opening degree and the intake pressure which are detected, and the amount of fresh air is applied to calculation of the exhaust gas recirculation rate. In the steady operation state of the engine, it is possible to accurately calculate the amount of fresh air sucked into the combustion chamber based on a detection value which is detected by the intake air flow rate sensor arranged on the intake passage. However, in the deceleration state (transient state), the amount of fresh air calculated based on the throttle valve opening degree and the intake pressure which are detected is more accurate. Accordingly, by using the amount of fresh air thus calculated, the exhaust gas recirculation rate exhibiting higher accuracy can be obtained in the deceleration state.

According to the fifth aspect of the present disclosure, in the control device for internal combustion engine according to any one of the first to fourth aspects, the load parameter (HETAC) is preferably a parameter representing charging efficiency of the engine.

According to this configuration, charging efficiency is used as the load parameter. It is possible to use the above-mentioned amount of fresh air or intake pressure, for example, as the load parameter. However, by using the charging efficiency, a load on the engine can be more accurately grasped, and determination of an execution condition of the specific retard control and setting of the specific ignition timing corresponding to the engine load can be accurately performed.

Obviously, numerous modifications and variations of the present invention are possible in light of the above teachings. It is therefore to be understood that within the scope of the appended claims, the invention may be practiced otherwise than as specifically described herein.

What is claimed is:

1. A control device for an internal combustion engine, comprising:
ignition timing control circuitry configured to control ignition timing in the internal combustion engine;
exhaust gas amount control circuitry configured to control an amount of exhaust gas recirculated to an intake passage via an exhaust gas recirculation passage in the internal combustion engine;
calculation circuitry configured to calculate an exhaust gas recirculation ratio of an exhaust gas amount in a combustion chamber of the internal combustion engine to an entire gas amount in the combustion chamber; and
retard circuitry configured to retard the ignition timing such that the ignition timing is on a retard side with respect to an optimum ignition timing at which the internal combustion engine outputs maximum torque and such that the ignition timing is before a compression process end timing in a cylinder of the internal combustion engine if the exhaust gas recirculation ratio is higher than a threshold ratio.

2. The control device according to claim 1, wherein when a load parameter representing a load on the internal combustion engine is equal to or larger than a predetermined load parameter value in a case where the exhaust gas recirculation ratio is higher than the threshold ratio, the retard circuitry does not retard the ignition timing.

3. The control device according to claim 2, wherein the retard circuitry retards the ignition timing as the load parameter is decreased.

4. The control device according to claim 1, wherein
the internal combustion engine includes a throttle valve provided to the intake passage,
the control device further comprises:
a throttle valve opening degree detection circuitry configured to detect an opening degree of the throttle valve; and
an intake pressure detection circuitry configured to detect intake pressure of the internal combustion engine, and
the calculation circuitry is configured to calculate an amount of fresh air sucked into the combustion chamber based on the opening degree and the intake pressure, and use the amount of fresh air for calculation of the exhaust gas recirculation ratio.

5. The control device according to claim 2, wherein the load parameter is a parameter representing charging efficiency of the internal combustion engine.

6. A control device for an internal combustion engine, comprising:
ignition timing control means for controlling ignition timing in the internal combustion engine;
exhaust gas recirculation control means for controlling an amount of exhaust gas recirculated to an intake passage via an exhaust gas recirculation passage in the internal combustion engine;
calculation means for calculating an exhaust gas recirculation ratio of an exhaust gas amount in a combustion chamber of the internal combustion engine to an entire gas amount in the combustion chamber; and
retard means for retarding the ignition timing such that the ignition timing is on a retard side with respect to an optimum ignition timing at which the internal combustion engine outputs maximum torque and such that the ignition timing is before a compression process end timing in a cylinder of the internal combustion engine if the exhaust gas recirculation rate is higher than a threshold ratio.

7. A method for controlling an internal combustion engine, comprising:
controlling ignition timing of the internal combustion engine;
controlling an amount of exhaust gas recirculated to an intake passage via an exhaust gas recirculation passage in the internal combustion engine;
calculating an exhaust gas recirculation ratio of an exhaust gas amount in a combustion chamber of the internal combustion engine to an entire gas amount in the combustion chamber; and
retarding the ignition timing such that the ignition timing is on a retard side with respect to an optimum ignition timing at which the internal combustion engine outputs maximum torque and such that the ignition timing is before a compression process end timing of a cylinder of the internal combustion engine if the exhaust gas recirculation rate is higher than a threshold ratio.
